(19) United States
(12) Patent Application Publication
(10) Pub. No.: US 2002/0194022 A1
(43) Pub. Date: Dec. 19, 2002

(54) System and method for delivering integrated health care

(76) Inventor: Florence Comite, New Haven, CT (US)

Correspondence Address: SHAW PITTMAN LLP, 1650 TYSONS BOULEVARD, MCLEAN, VA, 22102, US

(21) Appl. No.: 10/116,050

(22) Filed: Apr. 5, 2002

Related U.S. Application Data
(60) Provisional application No. 60/281,720, filed on Apr. 6, 2001.

(51) Int. Cl. G06F 17/60

(52) U.S. Cl. 705/2

(57) ABSTRACT

A system and method for delivering integrated health care to a patient, in which an embodiment of the system includes a site coordinator that creates a health portfolio for the patient, a nurse practitioner that answers questions raised by the patient concerning treatment, one or more allopathic specialists that review the health portfolio and propose allopathic treatments for the patient, a complementary-alternative medicine manager that provides the patient with information on complementary-alternative treatments, one or more complementary-alternative medical providers that review the health portfolio and propose complementary-alternative treatments for the patient, and a physician that reviews the health portfolio, evaluates the proposed allopathic treatments and the proposed complementary-alternative treatments, presents the proposed allopathic and complementary-alternative treatments to the patient, and consults with the patient to establish a treatment plan for the patient. The nurse practitioner manages the allopathic specialists. The complementary-alternative medicine manager manages the complementary-alternative medical providers.

This application claims the benefit of U.S. Provisional Application No. 60/281/720, filed Apr. 6, 2001, which is herein incorporated by reference in its entirety.

A portion of the disclosure of this patent document contains material that is subject to copyright protection. The copyright owner has no objection to the facsimile reproduction by anyone of the patent document or the patent disclosure, as it appears in the Patent and Trademark Office patent file or records. but otherwise reserves all copyright rights whatsoever.

### BACKGROUND

1. Field of the Invention

The present invention broadly relates to the field of customer services, and more specifically, to the delivery of integrated health care, including both allopathic medicine and complementary-alternative medicine.

2. Background of the Invention

A. Background

The current practice of health care delivery is rooted in the 18^{th} and 19^{th} centuries and has migrated from high-touch to high-tech. A new paradigm in health care delivery is essential given the sheer volume of the baby boomer population and the ultimate impact it will have on health care spending. The cost of any one of the significant chronic diseases will be enough by itself to bury us. For example, osteoporosis, which is currently estimated at a total cost of $15 billion, is anticipated to reach $60 billion in the near future as the population continues to age.

The “sandwich generation” faces a new challenge as medical advances continue to extend life expectancy (e.g., there are currently over 60,000 Americans over 100 years of age, according to Chris Cassell, M.D.).

Clearly, the demand is for a new paradigm in health care delivery that can effectively assimilate the explosion in science and technological capabilities. This paradigm needs to reach back in the pre-technology age where ‘healing’ was an art preformed by individual practitioners. Their ‘high-touch’ approach, which included knowledge of their patients' cultures, beliefs, and desire/ability to change, had a dramatic impact on their patients' health without many of the modern medical interventions.

Health care in the United States is delivered through a fragmented system of health care providers, including individual or small groups of primary care physicians and specialists. Concerns over the accelerating costs of health care have resulted in increased pressures from payors, including governmental entities and managed care organizations, on providers of medical services to provide cost-effective health care. Many payors are increasingly expecting providers of medical services to develop and maintain quality outcomes through utilization review and quality management programs but are still focused on a disease-based approach.

The current health care delivery system designates the primary care provider (i.e., family practice, internists, and gynecologists) to diagnose, treat, prevent, and coordinate care. It does not offer “patient-centered” services nor is it proactive in maintaining health and wellness. This leads to a fragmented system where the patients do not have access to any resources capable of coordinating feedback and direction from multiple sources. Managed care has exacerbated this situation by establishing the concept of a “gate-keeper” whose primary function is to control the level of care provided in disease-based situations as opposed to facilitating a comprehensive, integrated approach to wellness.

One could argue that this arcane system fits old lifestyles and health care patterns, rather than the high level of mobility and migration in today's culture. The current system is spiraling out of control with no capability of maintaining accountability for today's patients or keeping up with the medical information explosion (i.e., both diagnostic and therapeutic information). The “fix” requires a new system to leverage communication capabilities and new medical technology and techniques—along with the old.

Traditional medical practice is largely disease-based (not health-based), focusing on treating patients once they present with a particular disease. More pressing medical problems always take precedence over prevention. In fact, the medical system delivers disease based management programs in contrast to focusing on the patient and managing her life course with this disease. As a result of this traditional care paradigm, there is a significant unmet medical need for a comprehensive approach to diagnosis and treatment of the broad range of medical conditions that emerge in mid-life for both men and women. This is a recent phenomenon created by the increasing life expectancy of baby-boomers (e.g., in 1900, women lived to a mean age of 50 years old, while today the mean is 80—for men, in 1900, the mean life expectancy was about 42 years old, while today the mean is 72), leading to an increased level of chronic diseases in these later years.

While a number of physician practice management companies have developed a focus on obstetrics and gynecology, there are currently no well organized medical delivery systems that fully address the preventative and therapeutic needs of peri- and post-menopausal woman. Women's health and well being could therefore be vastly improved through a comprehensive program of preventative and curative treatment and guidance. Indeed, such a system would be of even greater benefit to men, who now typically receive only catastrophic care.

Conservative medical practice rarely incorporates the full spectrum of services. For example, it typically excludes analysis of health risk, nutritional health, and physical fitness. Some programs have been established in the area of “executive health programs,” which offer a broad range assessment and evaluation. However, these programs are generally hospital-based and non-integrative, and tend to be male oriented, with none addressing the specific needs of mid-life women.

B. Needs and Characteristics of Patients using Female Patients as an Example

The wide range of medical conditions that frequently emerge in women approaching mid-life (late 30's -60's) comprise a critical element of adult women's health care. Although these conditions are not necessarily gender specific, for illustrative purposes, this background discussion will address these issues in women. However, it should be noted that men experience a similar progression of conditions that would be approached in a manner appropriate for their gender.

When many women reach menopause, they begin to experience a number of associated physical and psychological symptoms. These symptoms can be related to fluctuating hormonal levels such as heart failure, palpitation, insomnia, and changes in hair and skin. In subsequent years, significant numbers of women will develop osteoporosis, cardiovascular disease (MI's and stroke), Alzheimer's, and metabolic and endocrine disorders. Furthermore, mid-life women are at increasing risk for a number of other conditions, including various cancers, arthritis, urinary incontinence, and visual and hearing disorders. In addition to the range of physical symptoms, women in mid-life frequently experience psychological disorders, including depression and other emotional problems, not necessarily related to their evolving hormone status, yet frequently handled as such. For example, assessment of cardiac function is rare in females—even for those at greater risk due to family history, elevated lipids, or obesity. In fact, one in nine females after age 44 have cardiac disease, expanding to one in three after age 65 (Farmingham Study, Department of Health, Education and Welfare; Publication #74, 1974, page 599). Yet, women with palpitation may be treated with Prozac™ or Zolof™, instead of exploring risk factors with an appropriate work-up for cardiovascular disease.

In the years following age forty, many of the most serious medical problems that afflict women, such as cardiovascular disease, osteoporosis, arthritis, clinical depression, and cancers of the breast, cervix, uterus, and ovary begin to increase dramatically. Cardiovascular disease, for example, once thought to be a “man's disease,” has now been shown to be equally prevalent in women once they enter per-menopause, and begin to lose the apparent protective effect of the reproductive hormones. Ironically, our mothers' nomenclature, the “change of life” comes far closer than the term “menopause” to capturing the significance of the physiological changes that occur simultaneous with the cessation of menstrual periods. The profound “change of life” that occurs at menopause includes a much increased risk of disease and disability affecting nearly every organ and function of the female body. Mid-life women are affected predominately or exclusively by five general high cost/high volume categories of medical conditions:

Cardiovascular disease: including heart disease and stroke, this condition is the number one killer of women (over 500,000 annually);

Osteoporosis: this condition contributes to wrist, spine, and hip fractures in 1 of 3 women in their 70's-80's. and costs $15 billion annually;

Cancer: primarily including cervical, ovarian, breast, colorectal and lung cancers, this condition affects 39% of all women;

Genitourinary infections: this condition affects more than 20 million women annually; and

Abnormal uterine bleeding: this condition affects 20% of all women seeing gynecologists.

Additionally, the issues of depression, sexuality, weight, aging appearance, and many other conditions are of paramount importance for these women. All of the above can be dramatically reduced by a prevention program that utilizes increased education and delivers credible information to women while creating a doctor-patient partnership with regard to shared decision making.

Less than half of the population seeking medical care expresses a concern or interest in long-term health problems such as osteoporosis, heart disease, or cancer. This fact would seem to reflect a situation in which the majority of women regard menopause as a short-term event and do not relate menopause to any potential long-term outcomes (The Journal of the North American Menopause Society, Spring 1994, NAMS-Gallup Survey on Women 's Knowledge, Information Sources, and Attitudes to Menopause and Hormone Replacement Therapy). This situation is exacerbated by the ineffective communication by the managed care and traditional health care systems regarding the need to reassess health status at the mid-life to implement evaluation of health risks. This approach tends to ignore the facts that cardiac disease and cancer generate significant risks to women. As an example, according to a 1995 American Cancer Society study, the following Table 1 summarizes the probability of women developing cancer:

TABLE 1
Probability of Women Developing Cancer

| Age | Probability |
|---|---|
| Birth-39 years | 2% |
| 40-59 years | 9% |
| 60-79 years | 23% |
| Lifetime (birth to | 39% |
| death) | |

Sixty-nine percent (69%) of all cancer in women is concentrated in the following five sites: Breast, Lung, Colon & Rectum, Uterus (cervical & endometrial), and Ovary. These risks can be minimized and potentially eliminated with appropriate care and lifestyle changes.

Current hormone user rates do not reflect long-term compliance, which is an important determinant of the risk of osteoporosis and coronary artery disease. It is estimated that 20 -30% of women who receive prescriptions do not fill them and of those who do fill their prescriptions 50% are noncompliant for the long-term (The Journal of the North American Menopause Society, Spring 1994, NAMS-Gallup Survey on Women 's Knowledge, Information Sources, and Attitudes to Menopause and Hormone Replacement Therapy). Additionally, hormone replacement therapy needs to be customized to each individual patient in order to maximize effectiveness and minimize related risks. However, currently the majority of women are placed on estrogen without consideration of the other alternatives, which should be customized based on the individual patient's profile.

Traditionally, women in menopause have been treated by their OB-GYN with hormone replacement therapy or just referred to a specialist if there is suspicion of more complicated health problems.

To illustrate this point, contrast a 25-year-old pregnant women being seen by her OB-GYN with her 50-year-old menopausal mother who, at the same time, is having her annual exam by the same doctor.

The pregnant daughter reaps the benefit of insights, advice, and support—relating to everything from exercise, nutrition, and vitamins to labor and delivery—from everyone at the office including the physician and mid-wife or nurse. She is instructed on every nuance of pregnancy—a process that lasts a total of 9 months.

Meanwhile, her 50 year old mother has a five minute exam with a Pap smear and is either handed a prescription for hormone replacement therapy or not, generally based on the physician's comfort level with the treatment, typically for symptoms related to the transitional impact/symptoms of menopause (i.e., hot flashes).

Rarely does the standard approach weave in family history, patient beliefs, and concerns about the therapy or current nutrition and lifestyle patterns. A patient-centered approach is virtually nonexistent given our current modes of health care delivery. It should be no surprise that only one in three patients fill their hormone prescriptions and most discontinue therapy within 30 days. In fact, it is more surprising that women remain on the therapy at all.

The current fragmented system leads to a situation where conditions and symptoms associated with aging and the inherent metabolic changes are typically treated by a disconnected array of other physicians, including those specializing in primary care, endocrinology, internal medicine, orthopedic medicine, psychiatry, and others. This system often leads to a lack of coordination, increased patient inconvenience, higher costs, and reduced efficacy.

Women recognize these limitations of the traditional fragmented system—which has been exacerbated, not improved, by increasing levels of managed care—and are seeking information about treatment approaches from other sources in order to manage their own care. A search of the Barnes and Noble™ Internet bookstore resulted in over 250 books about menopause. Additionally, a review of the responses generated with an Internet based Yahoo!™ Search for “women's health” generated almost eight times as many sites as a similar search for men. New sites seem to appear regularly for both genders. Table 2 below summarizes a representative Internet search for women's and men's health web sites, which is constantly evolving and difficult to evaluate with regard to validity of content.

TABLE 2
Internet Search

| Search Phrase | Categories | Sites |
|---|---|---|
| “Women's Health” | 14 | 430 |
| “Men's Health” | 4 | 56 |

In fact, the majority of women currently rely on sources of information other than medical professionals. Forty percent (40%) of women use news media (encompassing magazines, journals, books, TV, and/or newspapers) and 11% use friends and family for information. Moreover, of those who did receive information from their physicians, many felt that their physicians failed to address their primary concerns (Id.). Treatment options discussed by physicians with women reflect a singularly narrow approach. While variants of hormone replacement therapy were discussed with or offered to four in five women, there was little or no emphasis on nonhormonal options such as smoking cessation, exercise, diet, and stress reduction techniques, none of which was discussed by more than 2% of the physicians (Id.).

Increasingly, research is demonstrating that proactive management of health in the pre-, peri-, and post- menopausal years is a key determinant of a long and vital mid-life for women. As medicine has been traditionally practiced, however, women seeking treatment for the many symptoms of menopause and preventative recommendations to avoid its insidious potential outcomes often receive fragmented, incomplete, and poorly coordinated medical care from an unrelated group of specialty physicians at disparate sites. What women facing mid-life transition need is a “road-map”—an individualized prescription for therapy and lifestyle modification that is based on a thorough evaluation of the patient's health risks and an in-depth knowledge of available clinical options, including their benefits, cost, risks, and potential combination-incompatibility. The same need applies to men, and is perhaps even more vital if judged by their shorter life expectancy in contrast to women.

The growth in acceptance of alternative medicine also underscores patient dissatisfaction with traditional medical treatment of menopause, as just a single example. To illustrate this drive for alternative methods of treatment, remedies for menopausal symptoms such as wild yams and evening primrose have registered among the fastest growing herbal products.

C. Market Statistics

The United States Health Care Financing Administration has estimated that national health care expenditures in 1996 were over $1,035 billion, with approximately $202 billion directly attributable to physician services (Integramed America, Inc., Form 10-K, for the year ended Dec. 31, 1997). The alternative medicine and products market in the United States is also a market of significant size as documented in a study published in the New England Journal of Medicine in 1993 by Harvard researcher Dr. David Eisenberg:

Expenditure associated with the use of unconventional therapy in 1990 amounted to approximately $14 billion, with 75% of these being paid out-of pocket.

One out of four Americans who see their medical doctors for a serious health problem may be using unconventional therapy in addition to conventional medicine for that problem, 70% of these encounters are not reported to their medical doctors.

The estimated number of visits made in 1990 to providers of unconventional therapy (425 million) was greater than the number of visits to all primary care medical doctors nationwide (388 million).

Thus, there exists a gap between the traditional physician market and the fast growing alternative medicine market.

The market, while large, is also quite fragmented. According to the American Medical Association (“AMA”), in 1994 there were approximately 685,000 physicians actively involved in providing care in the United States. A 1993 AMA study estimates that there are over 86,000 physicians practicing in 3,600 multi-specialty group practices (consisting of three or more physicians) and over 82,000 physicians practicing in 12,700 single specialty group practices in the United States (Gyncor, Inc., Form S-1 Registration Statement filed Jul. 3, 1996).

The population of baby-boomer women is another dynamic trend enhancing the potential of a comprehensive program focused on preventing disease. In the United States, there are over 20 million peri-menopausal women (ages 40-50) and approximately 39 million post-menopausal women (over age 50). An additional 42 million women in the United States will reach age 50 over the next 20 years. Many women in the peri-menopausal range are asymptomatic, but have underlying health issues that begin to emerge with the onset of menopause (Integramed America, Inc., Form 10-K, for the year ended Dec. 31, 1997).

An analysis of the customer demographics for spas in the United States reveals the following profile. As of 1997, there were 862 spas in the United States of the following types (Spa-Finders Survey, 1997), as summarized in Table 3 below:

TABLE 3
U.S. Spas

| Spa Type | # |
|---|---|
| Destination Spa | 32 |
| Hotel/Resort Spas | 120 |
| Hotel With Small Amenity Spa | 110 |
| Day Spa | 600 |

The large majority—seventy-three percent (73%)—of spa clients are female (Id.). Additionally, fifty-one percent (51%) of these clients are between the ages of 35 to 54 years old. The typical spa client is affluent with seventy-nine (79%) having an income of greater than $50,000 per year (Id.). Table 4 below breaks down spa clients according to income.

TABLE 4
Income Levels of Spa Client

| Income | % of Total |
|---|---|
| $25-50 k | 20% |
| $50-100 k | 61% |
| $100 k+ | 19% |

The top four reasons people go to spas include: stress management, pampering, improved fitness, and weight management (Id.). It is relevant to note that three of the top four reasons (i.e., all except pampering) pertain to improved health, and that even pampering may have a positive, if unproven, impact on developing a sense of well-being. The present invention addresses this overlap between health care and pampering.

D. Key Trends

The following trends define both the dynamics of the market and needs that the present invention fulfills:

Baby boomers=“sandwich generation”—They are seeing their parents' health degrade at a later stage than past generations (at same time as raising own children), forcing them to make decisions for both the older and younger generation. This group is well educated, has a high-level of disposable income, and is not willing to take information at face value for anything, especially in terms of their personal and family health. At the same time, they are groping for ways to access and assimilate the tremendous amount of information that is now available to consumers. The number of aging baby boomers between the ages of 45 and 54 will increase by 75% from the mid-1990's to 2010.

Menopause is gaining in importance and focus—By one account, 3,500 American women enter menopause each day. Those numbers began to increase rapidly when the oldest baby boomers started turning 50 in 1996 (one every 7.6 seconds). As baby boomers move through middle age, the number of menopausal women will increase dramatically. Products and services that treat menopause symptoms are going beyond estrogen pills, as companies invoke “the change” to sell everything from calcium supplements to exercise videos.

Life expectancy is increasing—Due to longer lives, more focus is being placed on some of the preventable diseases that occur later in life for most women (e.g., osteoporosis, cardiac disease, and cancer).

Educated consumers—Consumers are becoming increasingly educated regarding health care alternatives due to the availability of information (e.g., Internet, news, and magazines), an unwillingness to take medical advice at face value and a desire to attain, maintain, and sustain health.

Women drive majority of health care decisions and costs—Women represent more than 50% of the overall population, and make 80-90% of all health care decisions (Dearing et al., Marketing Women's Health, 1987). After the age of 14, women visit the doctor 25% more frequently that men, are hospitalized 15% more than men, and consume 60% of health care expenditures (i.e., spend 2 out of 3 health care dollars) (Id.).

Growth in alternative/complementary medicine—The proactive, educated consumers are driving a significant increase in the area of alternative/complementary health care services and products. These services are typically provided on a fee-for-service basis paid directly by the consumer and are outside the traditional health care delivery channels.

Increased focus on retail health care—The increased focus on prevention, aging well, vitality and looks, living longer, sex, hair, and weight, all coupled with a growing frustration with traditional (now managed care oriented) health care system, is driving demand for alternative or traditional health care paid directly by the consumer.

Direct to consumer marketing activity is increasing—Examples include:

Drugs (e.g., Estrogen, Rogaine, Viagra),

Supplements (e.g., SlimFast, Ensure, vitamins),

Treatments (e.g., laser eye surgery, cosmetic surgery), and

Diagnostics (e.g., AIDs tests, pregnancy tests).

Limited payor focus on prevention—too much turnover exists in the health care system for payors to focus effectively on preventative care (i.e., the customers they provide coverage to do not stay with them long enough—only 18 months on average—for the payor to recognize the financial benefits from a preventive health program).

New diagnostics and therapeutics—result in more options and increased awareness yet challenge the physician and consumer due to an increasing complexity of decision-making.

### SUMMARY OF THE INVENTION

The present invention is a system and method for delivering personalized health services to consumers through medical consultation sites and a “state-of-the-art” technology platform. The present invention integrates quality medical services in physical and virtual settings to deliver cost-effective health care services to organizations such as corporations.

In one aspect, an embodiment of the present invention is directed to a system for delivering integrated health care to a patient. The system includes a site coordinator that creates a health portfolio for the patient, a nurse practitioner that answers questions raised by the patient, one or more allopathic specialists that review the health portfolio and propose allopathic treatments for the patient, a complementary-alternative medicine manager that provides the patient with information on complementary-alternative treatments, one or more complementary-alternative medical providers that review the health portfolio and propose complementary-alternative treatments for the patient, and a physician that reviews the health portfolio, evaluates the proposed allopathic treatments and the proposed complementary-alternative treatments, presents the proposed allopathic and complementary-alternative treatments to the patient, and consults with the patient to establish a treatment plan for the patient. The nurse practitioner manages the one or more allopathic specialists. The complementary-alternative medicine manager manages the one or more complementary-alternative medical providers.

In another aspect, the health portfolio includes at least one of past medical records, medical history questionnaires completed by the patient, a comprehensive physical examination report, laboratory results, diagnostic results, a health maintenance calendar, laboratory comparison studies, and educational materials.

In another aspect, the site coordinator, the nurse practitioner, the one or more allopathic specialists, the complementary-alternative medicine manager, the one or more complementary-alternative medical providers, and the physician operate out of a single medical site.

In another aspect, the medical site is located within a distance proximate to one of a hospitality facility, a planned community, a medical facility, and a diagnostic center.

In another aspect, the system further includes a database that stores the health portfolio. The database is remotely accessible to the patient through a computer network.

In another aspect, the one or more allopathic specialists include at least one of a nutritionist, an exercise physiologist, a physical therapist, a medical specialist, and a local primary care physician of the patient.

In another aspect, the one or more complementary-alternative medical providers include at least one of a lifestyle counselor, a behavioral health specialist, a Chinese medicine professional, a hypnotherapist, a chiropractor, a naturopathy specialist, a biofeedback therapist, and an energy work specialist.

In another aspect, an embodiment of the present invention is directed to a method for delivering integrated health care to a patient including collecting medical history information of the patient, reviewing the medical history information to identify any additional medical information needed, conducting an interview of the patient to obtain the additional medical information, identifying consultations beneficial to the patient, providing the patient with the identified consultations at a single medical site, and providing a patient with a report of the results of the identified consultations. The identified consultations include allopathic consultations by allopathic providers and complementary-alternative medicine consultations by complementary-alternative medicine providers.

In another aspect, the method further includes providing the patient with ongoing care in accordance with the report.

In another aspect, the method further includes providing the patient with remote online access to the report.

In another aspect, the report includes at least one of past medical records, medical history questionnaires completed by the patient, a comprehensive physical examination report, laboratory results, diagnostic results, a health maintenance calendar, laboratory comparison studies, and educational materials.

In another aspect, collecting medical history information includes receiving answers through an online questionnaire submitted remotely by the patient.

In another aspect, the allopathic providers include a physician and at least one of a nutritionist, an exercise physiologist, a physical therapist, a medical specialist, and a local primary care physician of the patient.

In another aspect, the complementary-alternative providers include at least one of a lifestyle counselor, a behavioral health specialist, a Chinese medicine professional, a hypnotherapist, a chiropractor, a naturopathy specialist, a biofeedback therapist, and an energy work specialist.

In another aspect, after conducting the interview and before identifying the consultations, the method further includes arranging one of a laboratory and a diagnostic test of the patient and receiving results of the test.

In another aspect, identifying consultations involves holding an integrated team conference among the allopathic providers and the complementary-alternative medicine providers. Participants of the integrated team conference evaluate the medical history information and the additional medical information and select consultations associated with the participants' disciplines.

In another aspect, the identified consultations include one or more of an integrated medical review, a comprehensive physical examination, an electrocardiogram with interpretation, a nutrition consultation, a lifestyle consultation, an exercise physiology evaluation, a bioelectrical impedance analysis, an elective consultation, a laboratory test, and a diagnostic test.

In another aspect, the medical site is located within a distance proximate to one of a hospitality facility, a planned community, a medical facility, and a diagnostic center.

In another aspect, the medical site is located on the premises of one of a hotel, resort, spa, and fitness club.

In another aspect, providing the patient with a report includes meeting with the patient to discuss the results of the identified consultations.

In another aspect, an embodiment of the present invention is directed to a system for delivering health care to a patient, in which the system includes a medical site that provides the patient with allopathic consultations and complementary-alternative medicine consultations, and a hospitality facility. The medical site is located on the premises of the hospitality facility.

In another aspect, the medical site includes an allopathic medical facility and a complementary-alternative medicine facility. The allopathic medical facility includes a nurse practitioner, a physician, and an allopathic medical team. The complementary-alternative medicine facility includes a complementary-alternative medicine manager and a complementary-alternative medicine team.

In another aspect, the allopathic medical team includes one or more of a nutritionist, an exercise physiologist, a physical therapist, and a medical specialist.

In another aspect, the complementary-alternative medicine team includes one or more of a lifestyle counselor, a behavioral health specialist, a Chinese medicine professional, a hypnotherapist, a chiropractor, a naturopathy specialist, a biofeedback therapist, and an energy work specialist.

In another aspect, the medical site and the hospitality facility share administrative functions, which include one or more of front desk reception, reservations, and scheduling.

In another aspect, the hospitality facility is one of a hotel, resort, spa, and fitness club.

In another aspect, an embodiment of the present invention is directed to a method for delivering integrated health care to a patient, in which the method involves scheduling an appointment for the patient to visit a medical site; receiving answers to medical information questions through a questionnaire completed by the patient; collecting medical records of the patient; reviewing and summarizing the questionnaire answers and the medical records; interviewing the patient before the visit to accomplish at least one of outlining preliminary recommendations for the visit, obtaining additional medical information, and arranging for one of a laboratory test and a diagnostic test to be conducted before the visit; identifying allopathic and complementary-alternative medicine consultations to provide during the visit; providing the allopathic and complementary-alternative medicine consultations during the visit to the medical site; documenting results of the consultations; and meeting with the patient to review the results.

In another aspect, documenting involves assembling a health portfolio that includes one or more of the questionnaire answers, a comprehensive physical examination report, laboratory test results, diagnostic test results, a health maintenance calendar, laboratory comparison studies, and educational materials.

In another aspect, the method further involves delivering ongoing care to the patient by updating the health portfolio and providing the patient with remote secure online access to the health portfolio.

In another aspect, delivering ongoing care involves one of managing a health issue identified during the visit, researching a health issue that arises after the visit, and administering behavior modification programs.

In another aspect, the medical site is located on the premises of a hospitality facility.

In another aspect, scheduling further involves scheduling a visit to the hospitality facility (e.g., a stay at the hospitality facility, including room reservations and activity appointments).

In another aspect, identifying involves holding at the medical site an integrated team conference among allopathic providers and complementary-alternative medicine providers. Participants of the integrated team conference evaluate the questionnaire answers and the medical records and identify consultations associated with the participants' disciplines.

In another aspect, the questionnaire is an online questionnaire remotely completed by the patient.

According to another embodiment, the present invention includes boutique medical sites that deliver personalized medical services to consumers and corporations in partnership with select spas and resorts. The present invention provides corporations and their employees with an innovative approach to medical delivery, focusing on preventive medicine as well as specific disease/condition intervention. Based on an innovative technology platform, the invention provides continuity and ongoing support in the delivery of health care services. Customized health programs integrate the most sophisticated elements of traditional and alternative medicine to optimize the return to health assets of clients, while minimizing their long-term risk. The invention also includes the services of nutritionists, physical therapists, psychologists, as well as alternative and complementary medicine clinicians, to deliver the most appropriate cost-effective care for each individual. Ongoing consultations and communications are available via a unique technology platform.

As another aspect of a representative embodiment of the present invention, the technology platform is a separate medical service offering that uses an innovative technology platform for monitoring, tracking, and managing health and lifestyle issues. The technology platform incorporates programs such as behavior modification, support groups, disease monitoring, and remote physician management. The technology platform provides the following:

Allows patients to remotely interact with their personal physicians, health care organizations, alternative medical providers, as well as with other patients with similar health problems, backgrounds, and interests;

Stores and tracks health information through a trusted record keeper that helps to automatically organize, build, and update a complete family health record; and

Provides recurring health risk assessments that help patients and their providers to better identify and manage health risks and to receive timely follow-up care through preventive care programs and results/treatment monitoring.

The present invention provides significant advantages to self-insured corporations, large health care delivery systems, and health insurance companies. To accommodate these institutions, the present invention offers a suite of “clicks and mortar” services that lower health care costs by facilitating proactive risk assessment and management of high-cost, problematic/complex, at-risk and non-compliant consumers. Consumers of these institutions can receive the services of the present invention as an enhancement to an existing relationship with the institutions (e.g., as a wellness benefit).

As benefits to the administrator of the system and method, the present invention provides multiple revenue streams resulting from both “clicks” and “mortar” services. The administrator's revenues are “fee-for-service” and/or product driven, whereas ongoing advisory (not primary) care revenues are generated on a per-member-per-month recurring basis. In another embodiment, there may also be revenues based upon select membership.

The present invention can include one or more of the following features:

1) A system and process that integrates a health care clinical center (akin to a doctor's office) with a hospitality facility such as a hotel, resort, spa, community center, or retirement village. The clinical center and hospitality facility share administrative functions such as front desk reception, reservations, and scheduling.

2) A system and method in which the backroom of the health care clinical center operates remotely from the hospitality facility.

3) A system and method in which the administrator of the health care service collects and assesses health information of a patient/client in advance of a visit, instead of the traditional manner of filling out paperwork during a yearly check-up. Analyzing the patient's medical history beforehand provides a customized, organized, productive, and time and cost effective visit.

4) A system and method that provides a patient with a health portfolio that defines all components of the patient's health and well being. For example, the health portfolio can include lifestyle preferences, nutrition, exercise, health risks, genetic makeup, drugs used, laboratory work, radiological reports, and disease history. The health portfolio is a repository of medical information independent from (yet may be integrated with) the conventional medical record systems maintained, for example, by managed care providers, primary and specialty physicians and clinicians.

5) A system and method that provides a connected relationship between a patient and health care advisory team. The patient becomes a partner in the administration of health care services. The health care advisors give a patient advocacy and guidance as the patient moves through different stages of his or her life. In an embodiment of the present invention, this advocacy and guidance is in addition to primary local care and catastrophic care.

6) A system and method that uses telemedicine to fulfill the medical needs of a patient/client. This system and method allows an individual, from before birth to death, to maintain contact with an advisory physician and health care advisory team, regardless of where the individual lives. The individual therefore stays “connected” with his or her health care providers who advise the individual to help the individual make informed decisions throughout life.

7) A system and method that delivers health care using a team of health care professionals. The patient works with the team based on her individual needs. For example, the team of health care professionals could include a physician, a psychiatrist, and an acupuncturist, and could evolve further over time based on developments with the individual's health. The team attends to the overall health of the patient, providing continuous ongoing guidance and care.

8) A system and method that delivers health care services under a patient-centric model, focusing on a patient's overall health and desires, rather than simply treating health problems as they arise.

9) A system and method of health care delivery that integrates traditional medicine with complementary and alternative practices, as appropriate.

Accordingly, an object of the present invention is to provide personalized integrated health care services.

Another object of the present invention is to provide integrated online and offline health services and a health portfolio management system.

These and other objects, aspects, and advantages of the present invention are described in greater detail in the detailed description of the invention and the attached materials. Additional features and advantages of the invention will be set forth in the description that follows, will be apparent from the description, or may be learned by practicing the invention.

### BRIEF DESCRIPTION OF THE DRAWINGS

FIG. 1 is a schematic diagram of an exemplary system for delivering health care, according to an embodiment of the present invention.

FIG. 2 is a schematic diagram of an exemplary method for delivering health care, according to an embodiment of the present invention.

FIGS. 3A and 3B are images of an exemplary operations checklist, according to an embodiment of the present invention.

FIGS. 4A-4F are images of an exemplary health portfolio clinical flow sheet for a female patient, according to an embodiment of the present invention.

FIGS. 5A-5E are images of an exemplary health portfolio clinical flow sheet for a male patient, according to an embodiment of the present invention.

FIG. 6 is an image of an exemplary health portfolio template letter, according to an embodiment of the present invention.

### DETAILED DESCRIPTION

A. Overview

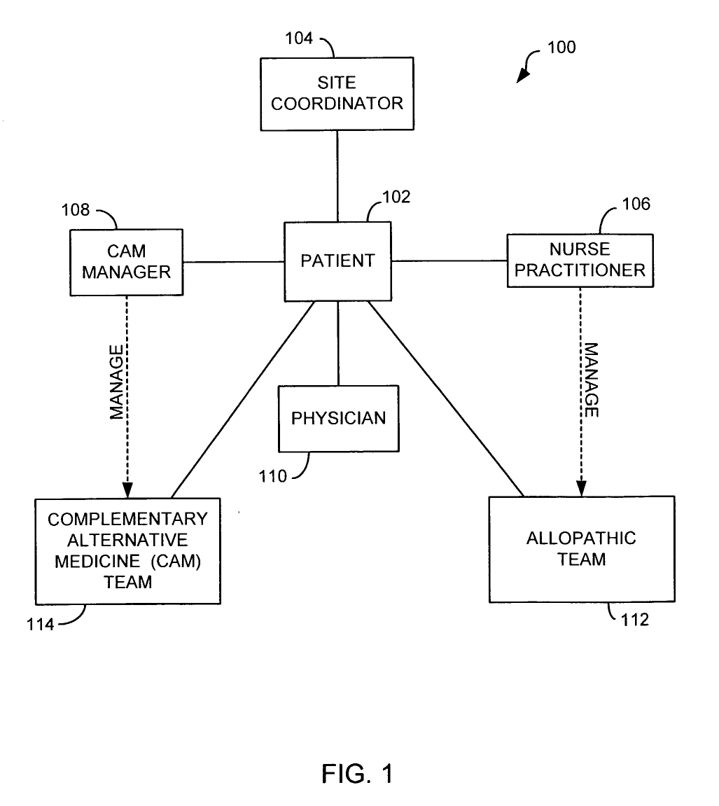

FIG. 1 illustrates an exemplary system 100 for providing a patient 102 with integrated health care, according to an embodiment of the present invention. As shown, system 100 includes a site coordinator 104, a nurse practitioner 106, a complementary-alternative medicine (CAM) manager 108, and a physician 110, which are referred to collectively as the core clinical team. Each of these participants is in communication with patient 102 and can communicate with the other participants of the system either directly or through site coordinator 104. As suggested by the central placement of patient 102 in FIG. 1, system 100 provides patient-centric care, which relies on the input of patient 102 in customizing health care solutions.

The names of the participants of system 100 (e.g., site coordinator, nurse practitioner, complementary-alternative medicine manager, physician, allopathic team, and complementary-alternative medicine team) are used herein to refer to person(s) who perform the functions commonly associated with persons having those titles. These names, however, are not intended to limit the specification and claims to persons having these particular titles. Thus, for example, “nurse practitioner” is not only intended to refer to persons having that title, but to other persons who may not carry that title but perform the functions associated with that title.

Patient 102 works with the core clinical team in customizing solutions appropriate to the unique health history, risk profile, and existing concerns of patient 102.

As the core clinical team, site coordinator 104, nurse practitioner 106, CAM manager 108, and physician 110 act as a trusted resource for patient 102 in guiding health management decisions, implementing behavior modification programs, and navigating new health information. This team gives patient 102 easy access to the expertise of an integrated medical program and contributes to patient 102's ability to sustain her health care strategies, a key variable in determining the long term success of a preventive health program.

The core clinical team serves as a hub, collecting health information from disparate sources within local networks of patient 102. The team is primarily responsible for integration and interpretation. Each member of this core clinical team represents a network of specialists that exist within her domain, all of whom are prepared to participate in the integrated model.

Site Coordinator 104 manages relationships with diagnostic and laboratory facilities. Preferably trained in integration logistics, site coordinator 104 is responsible for compiling medical records into a centralized system, preparing health portfolios, triaging on and offline issues to other appropriate members of the core clinical team, and managing the administrative components of integration. Site coordinator 104 works with the team in accessing and incorporating the clinicians relevant to the care of patient 102.

Nurse practitioner 106 shepherds patient 102 through the process of providing health care. For example, at the outset, nurse practitioner 106 conducts an initial interview of patient 102. To help patient 102 make health care decisions, nurse practitioner 106 also provides patient 102 with relevant information by, for example, consulting medical specialists and research data. Nurse practitioner 1 06 presents patient 102 with varying health care strategies and options, based on allopathic disease diagnosis and mainstream health care management.

If patient 102 chooses a traditional course of medical treatment (as opposed to complementary or alternative forms of treatments, discussed below), nurse practitioner 106 manages the resources required for that treatment. A traditional course of treatment falls under the realm of allopathy, which is defined as that system of medical practice which aims to combat disease by the use of remedies that produce effects different from those produced by the special disease treated, i.e., a term designating the ordinary practice of medicine, as opposed to homeopathy. Thus, for example, allopathic treatments exclude holistic, natural, non-medical, non-drug, and non-surgical forms of treatment. FIG. 1 shows allopathic resources as part of allopathic team 112, which acts as an extended clinical team that supplements the services provided by the core clinical team. As an example, allopathic team 112 could include a nutritionist, an exercise physiologist, a physical therapist, and a medical specialist. Allopathic team 112 could also include the local primary care physician of patient 102.

CAM manager 108 provides patient 102 with information and guidance on what are typically considered complementary or alternative health care options. CAM manager 108 analyzes and interprets both the allopathic and alternative medical history of patient 102, and introduces a non-Western perspective into the clinical discourse about patient 102. CAM manager 108 suggests complementary and alternative therapeutic options that are appropriate for patient 102. CAM manager 108 reports recommendations and findings to the core clinical team.

If patient 102 chooses a complementary or alternative medical treatment, CAM manager 102 manages the resources required for that treatment. FIG. 1 shows these resources as complementary-alternative medicine team 114, which acts as another extended clinical team that supplements the services provided by the core clinical team. As an example, CAM team 114 could include a lifestyle counselor, a behavioral health specialist, a Chinese medicine professional, a hypnotherapist, a chiropractor, a naturopathy specialist, a biofeedback therapist, and an energy work specialist. Optionally, nurse practitioner 106 could be involved with CAM team 114.

Physician 110 serves as a front to the specialty networks that lay behind him or her. Essentially, physician 110 synthesizes the health information that has been collected and works with patient 102 to establish, holistically, where patient 102 has been, where patient 102 is now, and how patient 102 wants to move ahead with her health care. In so doing, physician 110 reviews the health portfolio, evaluates the allopathic treatments proposed by allopathic team 112 and the complementary-alternative treatments proposed by CAM team 114, presents the proposed allopathic and complementary-alternative treatments to patient 102, and consults with patient 102 to establish a treatment for the patient 102.

Overall, as a core clinical team, site coordinator 104, nurse practitioner 106, CAM manager 108, and physician 110 manage the diverse needs of patient 102 without assuming the costs of all in-house clinicians. Interacting directly with patient 102, this core clinical team also delivers highly personalized and integrated care, inevitably resulting in better health outcomes.

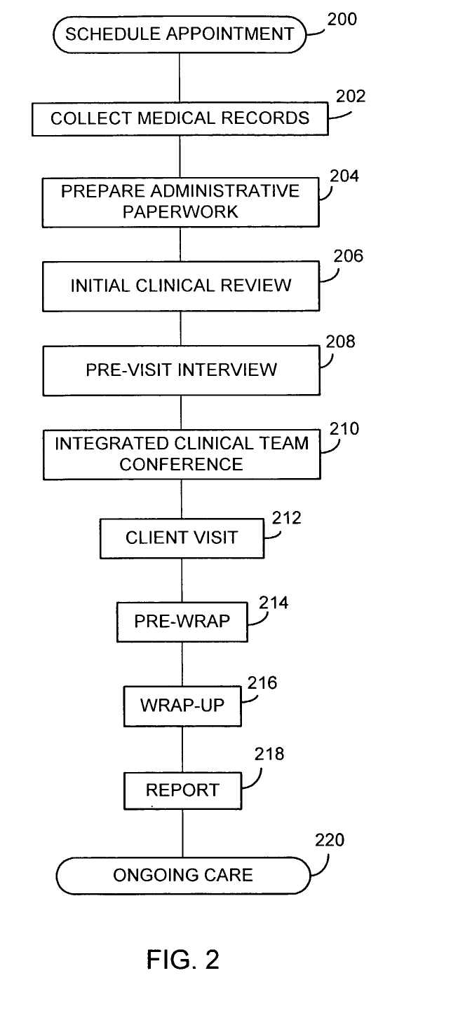

With reference to the participants of system 100, FIG. 2 describes an exemplary method for delivering health care, according to an embodiment of the present invention. This particular example traces the delivery of health care by system 100 from the enrollment of patient 102 through to ongoing advisory care.

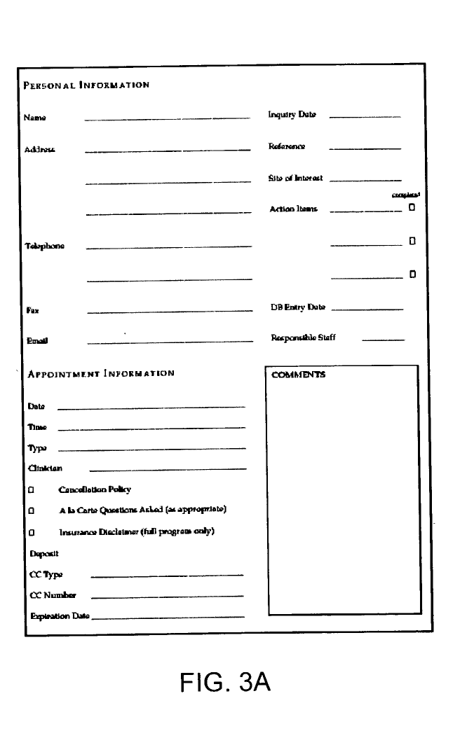

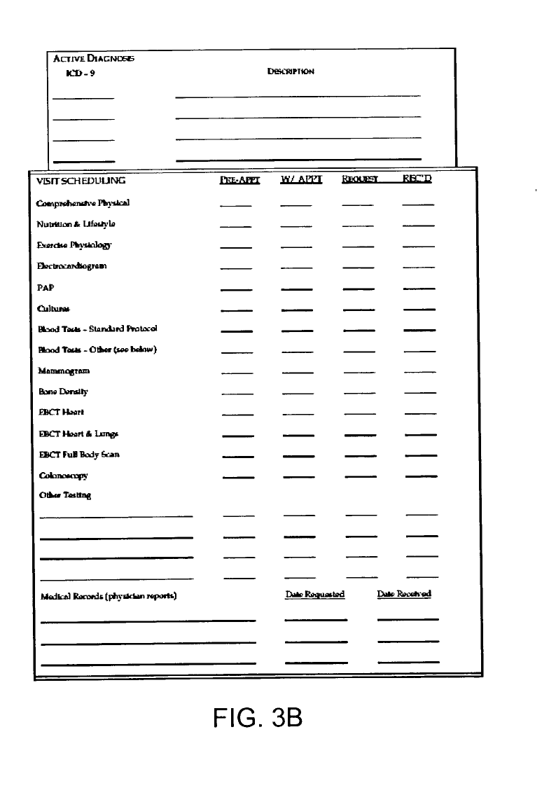

As shown in FIG. 2, the method begins in step 200 with the scheduling of an appointment for patient 102, which involves the opening of an operations checklist, the preparation of administrative paperwork, and the establishing of a health portfolio. Appointments are preferably scheduled four to six weeks in advance of a visit. Upon the inquiry by the patient 102, site coordinator 104 captures demographic and appointment information in an operations checklist, which becomes the front page of every chart for patient 102. FIGS. 3A and 3B illustrate an exemplary operations checklist.

Also as part of step 200, site coordinator 104 prepares administrative paperwork, such as a financial policy, registration form, authorization to obtain and release medical records, and HIPPA information and consents.

To establish a health portfolio for patient 102, site coordinator 104 gives patient 102 health portfolio questionnaires. These questionnaires can be paper-based (e.g., completed by facsimile correspondence or through the mail). Preferably, however, site coordinator 104 gives patient 102 a code with which to access health portfolio questionnaires online. The questionnaires ask patient 102 for background medical information including, for example, surveys directed to medical history, sexual and reproductive health, body condition (e.g., exercise, fitness, and posture), skin, hair, nails, nutrition history, and psychological health. The information provided through the questionnaires populates the health portfolio. The health portfolio provides a diagnostic tool for analyzing a patient's needs and developing a plan of care. It also acts as a health risk assessment instrument that assists in the prioritization of the treatment plan and customization of care. After the initial consultation, updating the health portfolio, either by patient 102 or the core clinical team, assists in the management of both short and long term health issues. Indeed, the health portfolio serves as a virtual hub for the ongoing collection and integration of medical information, providing a comprehensive resource for all pertinent health information of a patient. Patient 102 and the core clinical team can remotely access the health portfolio to help expedite health care decisions, especially under emergency circumstances.

After the appointment for patient 102 is scheduled, in step 202 site coordinator 104 collects medical records of patient 102. In order for site coordinator 104 to have access to the records, patient 102 submits signed medical record release authorizations to patient 102's physicians and specialists, who then send the records to site coordinator 104. Upon receipt, site coordinator 104 makes the records a part of the history section of the health portfolio. The core clinical team reviews the records and integrates them into the comprehensive assessment of patient 102.

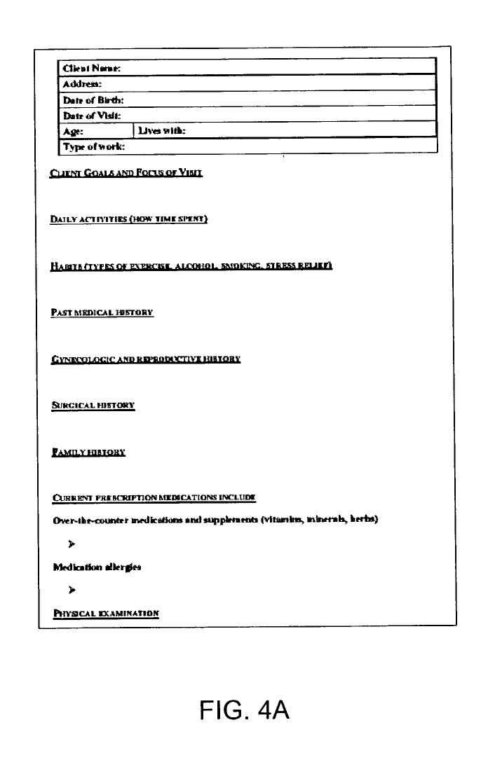

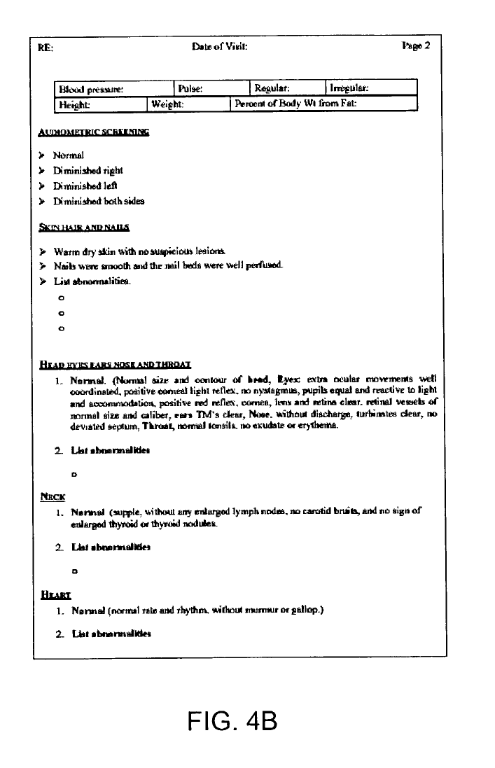

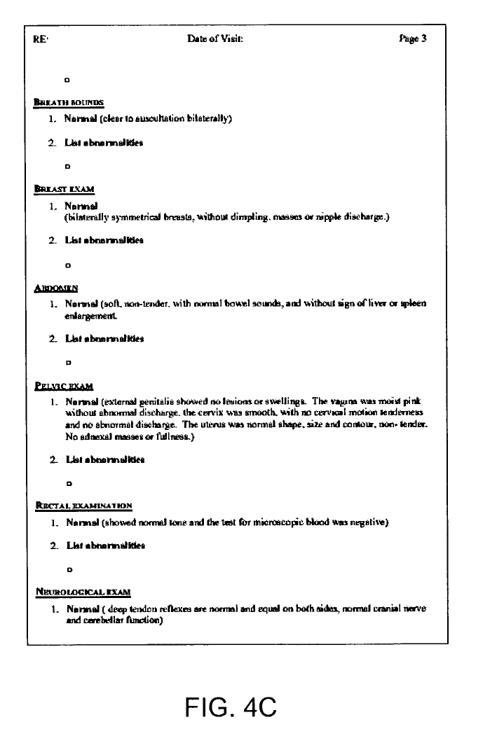

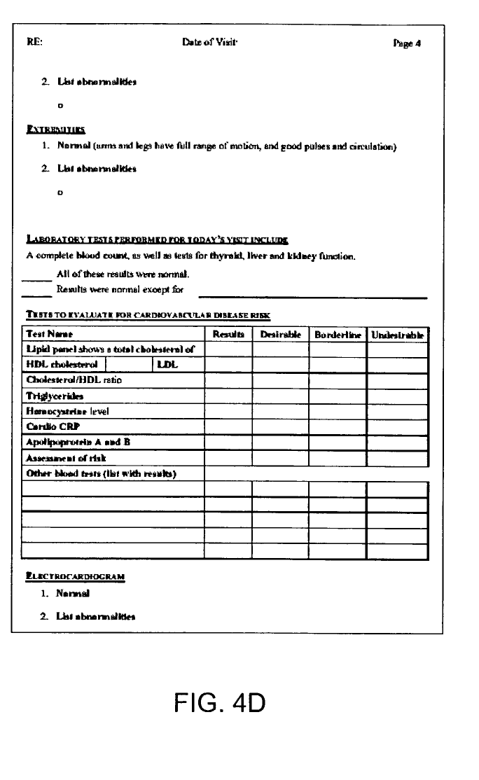

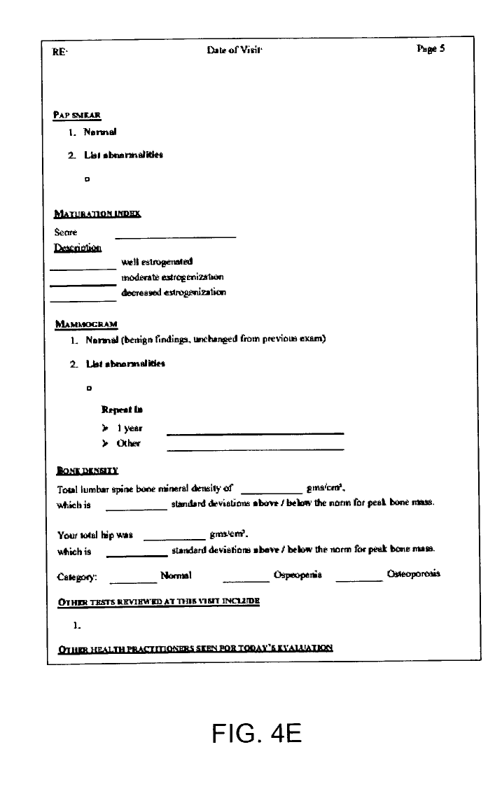

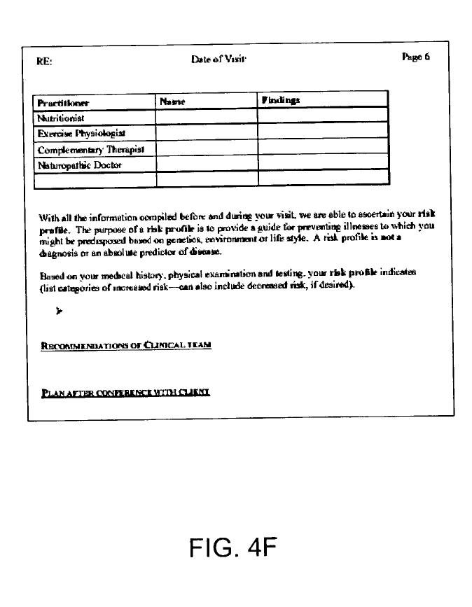

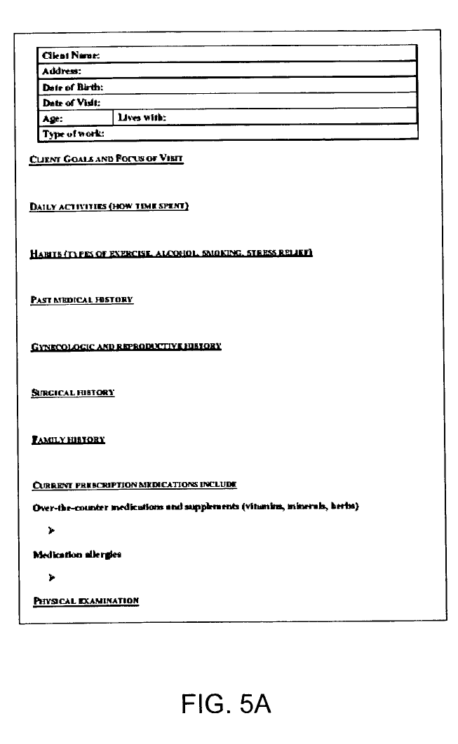

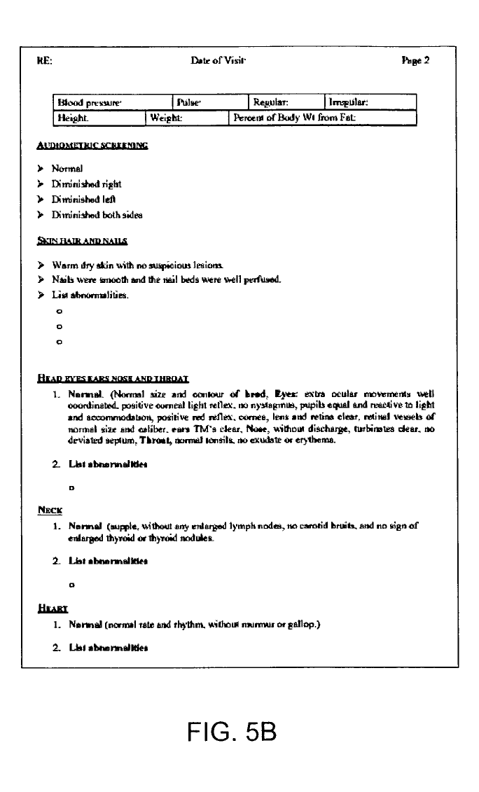

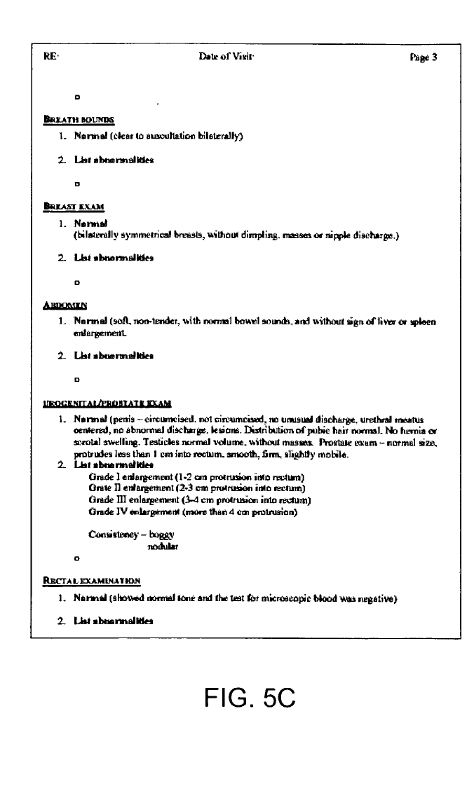

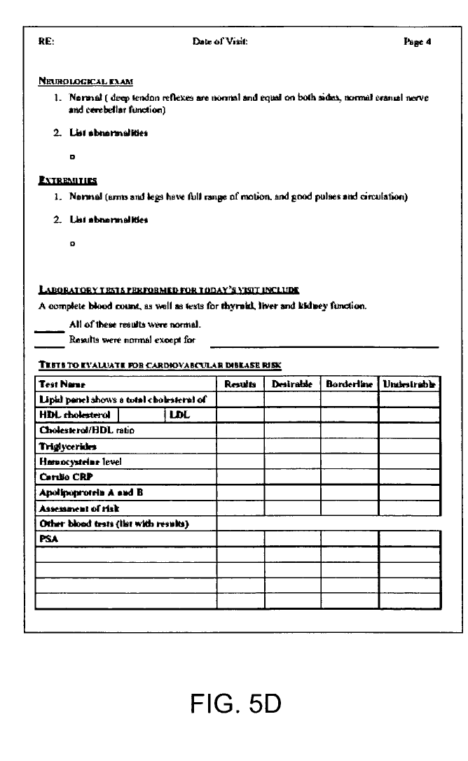

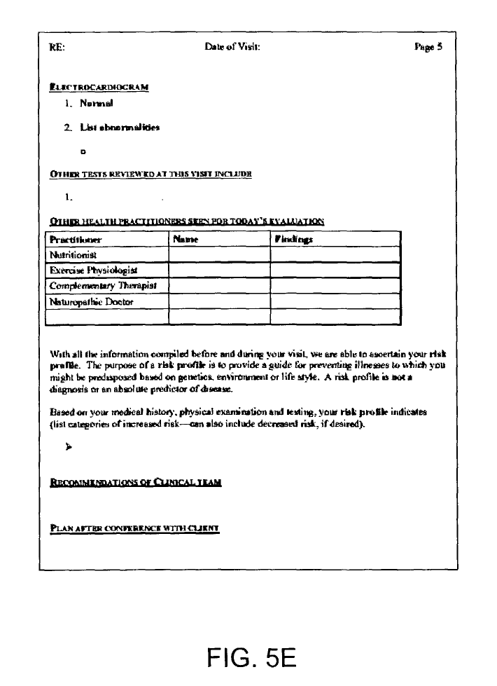

In step 204, after the questionnaires have been completed by patient 102, site coordinator 104 prepares the administrative paperwork necessary for new patient intake. For example, site coordinator 104 assembles a physical chart that the core clinical team uses for chart reviews. Site coordinator 104 also begins a health portfolio clinical flow sheet, which will be used to document all information associated with reviews of patient records, patient interviews, scheduling, physical examinations, consultations, and clinical meetings. The health portfolio clinical flow sheet captures all of the information needed (except perhaps test results) to complete a comprehensive report template (discussed below). FIGS. 4A-4F and 5A-5E show exemplary health portfolio clinical flow sheets for female and male patients, respectively.

In an alternate embodiment of the present invention of steps 200, 202, and 204, a nurse performs one or more of the steps, instead of site coordinator 104. Of course, site coordinator 104 could also be a nurse.

After the medical records are collected and the questionnaires returned, in step 206 nurse practitioner 106 and CAM manager 108 conduct an initial clinical review. As part of this initial review, nurse practitioner 106 and CAM manager 108 extrapolate summary information from the questionnaires and medical records and place the information on the health portfolio clinical flow sheet. Nurse practitioner 106 and CAM manager 108 also form an initial clinical impression of patient 102 and formulate a draft customized clinical program. The initial clinical review also determines if further medical information about patient 102 is needed.

In step 208, nurse practitioner 106 conducts a telephone interview of patient 102 to share initial impressions, outline preliminary team recommendations for the visit, ask any questions that developed out of the questionnaire, and arrange for any laboratory or diagnostic testing that should precede patent 102's visit. At this time, nurse practitioner 106 also gathers feedback on what elective treatments the clinical team thinks might be most beneficial.

In this step, nurse practitioner 106 uses the health portfolio clinical flow sheet as a guide in conducting the telephone interview of patient 102. Nurse practitioner 106 then completes the operations checklist at the front of the chart, providing coding and scheduling requirements for patient 102. Nurse practitioner 106 then gives the active chart to site coordinator 104 who refers to it for scheduling and completing paperwork for all pre-visit testing and on-site consultation. Nurse practitioner 106 can also begin scheduling components of the eventual visit of patient 102.

After the telephone interview and in preparation for the visit of patient 102, in step 210 members of the core clinical team and any CAM practitioners that are involved in patient 102's care meet for an integrated team conference. As an example, the attendees of this meeting could be nurse practitioner 106, physician 110, a clinical nutritionist, an exercise physiologist, an acupuncturist, and a naturopath. In one embodiment of the present invention, the attendees meet in person at a single medical site. In another embodiment of the present invention, the attendees meet via means other than in person, such as by telephone conference, video conference, or Internet conference. In this manner, the members of the clinical team can operate out different sites.

Each participant in the integrated team conference evaluates the medical history information (e.g., questionnaire results), contributes her expertise, and suggests treatments associated with the participant's discipline, with the goal of integrating all of patient 102's health issues into a holistic picture of patient 102's health and deciding on which aspects of the patient 102's health should be investigated when patient 102 visits. For example, the results of the conference could include arranging for appropriate laboratory and/or diagnostic testing, consulting specialists, and evaluating different approaches and conducting research to take advantage of all health resources that may be of value.

In an embodiment of step 210, nurse practitioner 106 presents the medical information of patient 102 to the integrated team and outlines the tests and components of the visit that have been preliminarily scheduled. As a hypothetical example, nurse practitioner 106 might present the following:

Nancy Sweer is a 63 year-old female who comes to us seeking a comprehensive health assessment with particular emphasis on symptoms of thyroid dysregulation. In particular, she is concerned about a weight gain of thirty pounds over the past year. She is G4, P4 and has a history of vocal cord stripping×2 and TAH at age 49 for metrorrhagia. She has not used ERT since that time. She is in an unhappy marriage that she is contemplating leaving. She is not sexually active. Her health maintenance profile reveals that she needs a pap, a mammo, and blood tests including CBC, TFTs with TSH etc. She has never had a bone density test. We will do a Pap at the visit and schedule a mammo and bone density test. In addition, we recommend including guided imagery for stress and weight management issues, and PT and a personal trainer for exercise counseling.

After this presentation, the team then discusses the proposed program, provides feedback and refines the program into an optimal customized program.

Following the team conference, in step 212 patient 102 visits a medical site for consultations with each member of patient 102's clinical team, including the core and extended members. This medical site could be an individual medical office. Preferably, however, the medical site is located on the premises of or proximate to a hospitality facility, a planned community, a medical facility, or a diagnostic center. A proximate location could be any location from within walking distance to accessible within a reasonably short time by transportation (e.g., shuttle, bicycle, or golf cart).

Examples of hospitality facilities include hotels, resorts, spas, and fitness clubs. By combining the integrative health care delivery of the present invention with the reputation of a highly-regarded hospitality facility, the present invention creates a synergy that enhances the marketing and improves the business of both the hospitality facility and medical site. The medical site gives the hospitality facility a unique opportunity to differentiate itself in an increasingly saturated market space. The medical site provides a consistent source of patients and clients to feed directly and indirectly to the revenue centers of the spa and resort. The trust generated in the “high touch” relationships that patients form with their health advisory team provides a client base within which family and friend referrals are a strong source of new growth. Thus, the present invention can independently appeal to an expanded market of financially independent clients and corporations that is ever more likely to give their ongoing loyalty and patronage to the sheltering site.

An example of a planned community is a retirement community. In this implementation, the medical site is located among the residents of the community, providing convenient access to integrated medical care. The services provided by the medical site increase the value of the properties in the planned community.

Examples of medical facilities include hospitals, diagnostic centers, assisted living facilities, and nursing homes. Capturing the trust of an aging population is a primary incentive for bringing a distinctive, substantive prevention-based program to an established medical facility, such as a hospital. Providing a consistent source of volume to feed into hospital revenue centers, the present invention keeps patients in-house for sophisticated laboratory and diagnostic testing, specialty referrals, treatment, and associated procedures. The present invention therefore fosters a loyal midlife market that is more likely to age within the associated medical facility (i.e., hospital) system.

While riding the wave of preventive medicine and self-care trends, innovative health care programs must be prepared to manage the transition to disease management effectively. The same consumer that demanded integrated care and access to expertise for her wellness care is going to want a deep trusted network, already established, to respond to the inevitabilities of even the healthiest aging process. Geriatrics will take on an entirely new definition in the next ten to fifteen years. The integrated health care delivery of the present invention addresses the needs of this next era of health care.

Regardless of where the medical site is located, the consultations of step 212 (as prescribed by the integrated team conference in step 210) can include one or more of the following services: integrated medical review; comprehensive physical examination; electrocardiogram with interpretation; nutrition consultation; lifestyle consultation; exercise physiology evaluation; bioelectrical impedance analysis; elective consultations; and laboratory and diagnostic testing.

An integrated medical review is based on the results of the integrated team conference of step 210. One or more members of the integrated team (e.g., physician 110 or nurse practitioner 106) meet with patient 102 to review the health portfolio clinical flow sheet. The portfolio includes patient 102's personal and family medical history, patient 102's medical records from primary and specialty care providers, and the completed questionnaires that provide critical health and lifestyle information. The integrated medical review and consultation with patient 102 lay the foundation for a comprehensive health assessment.

A comprehensive physical examination further investigates, confirms, and supplements the information gathered through medical records and questionnaires.

An electrocardiogram with interpretation is a specific service for assessing the health of the heart. The test and evaluation establish a baseline study of patient 102's heart rate, rhythm, and conduction system, allowing clinicians to spot irregularities that warn of current or future problems. Furthermore, the baseline electrocardiogram report enables future comparative studies.

A nutrition consultation gives patient 102 an understanding of the impact of food on patient 102's metabolism, moods, hormonal balance, and medical conditions. The knowledge of the connection between diet and health and wellbeing provides the foundation for positive change. In partnership with patient 102 and the other members of the clinical team, a nutrition specialist designs a sustainable nutrition plan that suits the lifestyle and goals of patient 102.

A lifestyle consultation focuses on how the knowledge and experience gathered during patient 102's visit can translate into meaningful changes in day to day existence. A lifestyle specialist works with patient 102 in identifying barriers that may exist in implementing the strategies developed by patient 102 and the clinical team.

An exercise physiology evaluation develops an exercise routine for patient 102. This routine ensures that patient 102 has balanced all components necessary to maximizing a fitness workout. The physiology evaluation also identifies ergonomic adjustments in the daily life of patient 102, which can help protect musculoskeletal systems and address any targeted physical problems.

A bioelectrical impedance analysis is a sophisticated tool for measuring the body's composition. Through electrical conduction, this extremely sensitive instrument can determine the percentage body fat relative to the fat free mass (intracellular mass and body cell mass) in the body of patient 102. Results of this assessment contribute to the type of workout regimen that is prescribed. In consultation with patient 102, the exercise physiologist tailors recommendations to fit the lifestyle, preferences, and other health goals of patient 102.

Additional elective consultations can cover any number of therapeutic treatments and specialty services. For example, a patient exploring alternative approaches to hormone replacement may want to work with a naturopathic doctor alongside her allopathic doctor in order to learn about herbal recommendations. Another patient whose main concerns are stress management and residual pain from a neck injury might want to use these elective consultations to explore the benefits of hypnotherapy and acupuncture.

Laboratory and diagnostic testing is useful for integrating medical care, especially with respect to prevention. Often, useful laboratory tests and diagnostic procedures are neglected when health care is fragmented. An example of such testing is the DEXA bone density scan that evaluates risk for osteoporosis, a debilitating disease that is preventable but is often caught too late. Another example of useful testing, when indicated, is EBCT and Spiral CT, which are new CAT scan technologies that are tremendously effective in detecting early pre-symptomatic disease in the heart and lungs. As part of laboratory and diagnostic testing, after review of patient 102's medical records, the testing consultation involves determining which tests are medically appropriate to the unique profile of patient 102, and explaining to patient 102 the purpose of the tests and their potential benefits.

In one embodiment of the present invention, the consultations and diagnostic and/or therapeutic interventions of step 212 are conducted at a single medical site. In another embodiment, one or more of the consultations and diagnostic and/or therapeutic interventions take place prior to a visit or in a follow-up, at any time deemed necessary, depending upon follow-up.

Referring again to FIG. 2, after the comprehensive health assessment and individual consultations, in step 214 the members of patient 102's core and extended clinical team complete a pre-wrap of patient 102's visit. For this pre-wrap, individual members of CAM team 114 report to CAM manager 108 and the individual members of allopathic team 112 report to nurse practitioner 106. The members of teams 1 12 and 1 14 make these reports by documenting their consultations on the health portfolio clinical flow sheet. Also as part of this pre-wrap, the members of patient 102's core and extended clinical team can meet to discuss the collective clinical impressions and the results of all testing and consultation that has been conducted.

In step 216, one or more members of the core and extended clinical team (e.g., physician 110 and an acupuncturist) conduct a “wrap-up meeting” with patient 102. This meeting is a strategy session with the patient 102, aimed at conveying information regarding test results and other findings and impressions, and at developing a care plan that reflects the input of the clinical team and patient 102. Prior to the meeting, the members of the clinical team that are to attend the meeting discuss with each of the clinicians involved in patient 102's customize program (e.g., acupuncturist or hypnotherapist) the approach they took in the services that they provided and the response of patient 102 to the services. The members also review all test results and prepare to discuss the results with patient 102, and to propose follow-up and treatment, as needed.

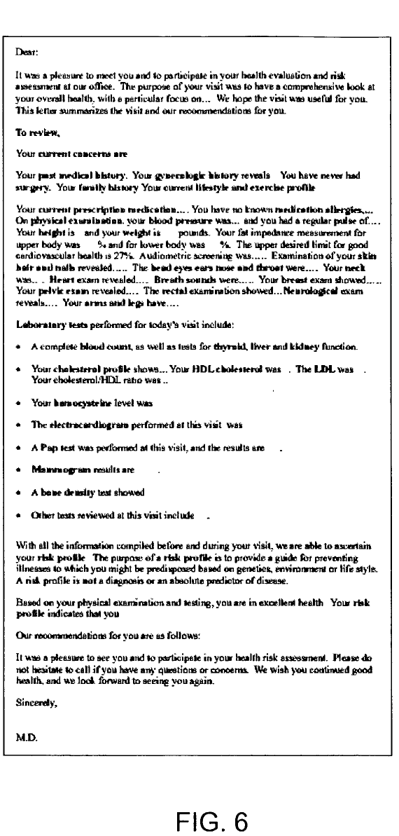

At the conclusion of the wrap-up meeting, in step 218 patient 102 is given access to her health portfolio, which includes one or more of the questionnaire, the comprehensive report (with copies for local physicians, if desired), laboratory and diagnostic results, a health maintenance calendar, laboratory comparison studies (progression data), and educational materials. Patient 102 could receive a hard copy of these documents. Preferably, however, patient 102 is given remote access to the health portfolio information online. Site coordinator 104 builds the health portfolio using the health portfolio clinical flow sheet, which captures all of the data from the previous steps described above. Site coordinator 104 conveniently enters the data into a template letter such as the letter shown in FIG. 6. Optionally, as part of step 218, nurse practitioner 106 reviews and personalizes the health portfolio, including, for example, additional relevant research and educational materials.

After patient 102 has left the medical site, in the optional step 220 the core and extended clinical team of patient 102 provide ongoing advisory care. This ongoing care includes, for example, management of a particular health issue, further research on an issue that arises after the visit, and behavior modification programs. Unless a physical examination is necessary, the core and extended clinical team can deliver this integrated health care remotely by updating the health portfolio of patient 102, which simultaneously populates the medical record and chart. Patient 102 can then securely (e.g., providing a username and password) and remotely access the portfolio.

The health portfolio contains administrative paperwork (e.g., medical records release forms and insurance registrations), comprehensive health histories (based on questionnaires), past medical records, visit histories, ongoing patient management information, updates to questionnaires (abbreviated questionnaires for subsequent visits), and client tools. The visit histories can include clinical assessment support tools, health records, comprehensive reports, consultation reports (e.g., nutrition and exercise physiology reports can be freestanding), and a health maintenance record (e.g., colonoscopy every four years). The client tools can include educational materials, prescriptions, and self-monitoring programs.

Overall, the central storage of patient 102's medical data in the health portfolio provides a prevention-centric integrated model of health care delivery. The online portfolio makes it easier to send and retrieve the initial survey instrument, analyze the results, and disperse the portfolio to members of the core and extended clinical team, wherever they may be. The online health portfolio can also include formulas for analyzing results, graph functions for viewing changes in results over time, and reporting and decision support functions. The online portfolio can provide CPT and ICD 9 codes for procedures and diagnoses, and can assist in obtaining and storing medical records from other health care providers. Thus, the online heath portfolio can increase efficiency and accuracy of documentation for health care providers, can lessen paper burden and decrease chart size, and can decrease the need to input the same information into different parts of the record.

The system and method of the present invention redress the shortcomings of the conventional fragmented disease-based approaches to health care services, which lead to conflicting and inappropriate treatments. The present invention proactively integrates patient-centered health care and optimizes emerging diagnostics and therapeutics via proactive coordination of the patient-clinician relationships.

The present invention provides a network of sites that create a new paradigm of health care delivery. Its unique diagnostic protocols and clinical pathways are the cornerstone of this novel model of health care delivery. The approach incorporates the best of conventional western medicine and eastern philosophy, along with combining the high-tech capabilities of modern technology with a high-touch implementation approach.

The present invention accepts overall accountability including, needs assessment, coordinated access to appropriate treatment, management of the treatment/care process, information management for patients, reporting to the patient's personal health care team, recording of personal history/background at an unprecedented level and pushing the boundaries of traditional health care services and delivery. The incorporation of the patient's voice (including their beliefs, feelings, fears etc.) in the planning, evaluation, and implementation phases distinguishes the program and establishes the patient to be part of the solution. The sum total of this approach creates a new paradigm in health care that generates positive outcomes. In contrast to conventional models, this new paradigm is: patient-centered instead of provider driven; based on preventive care rather than disease recognition; provides personalized services and integrated care rather than general services and fragmented care; emphasizes accountability as opposed to passing the buck; and focuses on the patient as a partner and healer rather than the doctor as deity and healer.

In addressing the deficiencies of the prior art, an embodiment of the present invention provides a novel health care model based on the guiding principles summarized in Table 5 below:

TABLE 5
Health Care Model

| | |
|---|---|
| Patient-Centered | Health care services that are driven by the patient and |
| Care: | not by the physicians. |
| Preventive Care: | The care is preventive or proactive as opposed to |
| | reacting to disease symptoms that have already |
| | manifested themselves. |
| Personalized | The program delivers a level of service |
| Service: | unmatched in the provision of health care and |
| | uses concierge level quality in meeting the |
| | client's needs. |
| Integration of | The program synchronizes all aspects of the |
| Care: | client's health care needs and acts as the |
| | ‘ombudsman’ with all participants in the |
| | patient's health care team. |
| Accountable | The administrator of the present invention takes |
| Medical Care: | responsibility for managing a shared decision- |
| | making approach in a fragmented health care |
| | system that currently assumes limited |
| | accountability. The “patient-centered” |
| | approach creates accountability in one entity |
| | that provides discernment/interpretation of the |
| | client's total health care needs -ranging from |
| | facilitating access to innovative monitoring |
| | capabilities. |
| Patient | The patient is incorporated into the process |
| Accountability: | and made a partner in the delivery of care via |
| | education and support with the understanding, |
| | insight and control leading to effective self- |
| | directed care. Included in this is behavior |
| | modification where necessary to change unhealthy |
| | habits (e.g., smoking, lack of exercise, poor diet |
| | etc.) |

B. Service Concept

In an embodiment of the present invention, service offerings consist of two interrelated programs providing for both wellness and intervention. Both the Wellness and Intervention programs focus on combining traditional Western medicine with alternative medicine such as acupuncture, herbal, aromatherapy, and massage treatments. They are interrelated in that the Wellness Program will often be followed up with the Intervention Program to implement lifestyle changes or address specific issues as identified by the “road-map.” Likewise, the Intervention program will generate referrals for the Wellness Program. Each of these programs are outlined below:

1. Wellness Program

The Wellness Program is built around a comprehensive assessment to ascertain current health status and future risks, with the result being the creation of a personalized comprehensive “road-map” to attain and maintain health. The primary component of the Wellness Program is the comprehensive medical evaluation—which can be either a one-day session or multi-day sessions.

The program is primarily directed toward the mid-life population because it is a time of life when multiple health questions arise, mid-life symptoms start to appear, and risk factors for chronic disease and family health history acquire more relevance. Additionally, for women, hormonal replacement therapy becomes an issue to resolve and certain types of diagnostic screening tests (e.g. mammography, lipid profile, and sigmoidoscopy) are recommended. Consequently, the majority of patients that access the Wellness Program are in the 40-60 age group.

2. Intervention Program

The Intervention Program is targeted toward disease/condition management, consisting of multiple visits/remote communication sessions to aggressively and proactively coordinate all resources required to effectively manage the process. These typically take the form of Focused Consultations (with a physician and/or nurse practitioner) and periodic consultations (with either a physician or nurse practitioner). The process is generally focused on specific objectives or health problems, which may include patients who:

Seek a specialist's opinion,

Are implementing a significant personal plan of action and need periodic updates or monitoring for such items as:

hypertension,

elevated lipids, or

lifestyle intervention.

Need to address specific health problems such as:

Cancer (e.g., breast, lung, and colon),

Cardiac disease,

Estrogen/hormone therapy,

Pulmonary disease,

Stress,

Excessive or irregular menstrual bleeding,

Fertility,

Sexuality,

Skin disorders,

Osteopenia, or

Osteoporosis.

The present invention uses telemedicine capabilities (e.g., email, telephone, fax and Intranet) to remotely monitor (e.g., daily, weekly, monthly etc.) ongoing progress and compliance with the patient's individual plan of action.

3. Additional Programs

In addition to the primary programs outlined above, in further representative embodiments, the present invention includes product offerings that support the dynamic process of facilitating a healthy lifestyle. In addition to the comprehensive approach outlined above, representative embodiments of the present invention can include the following targeted programs:

Dermatology—dermabrasion, collagen, botox, scleratherapy, and deep facials

Managed Care—preventive and intervention programs provided through managed care organizations

Libido/Sexuality—detection, intervention

Geriatric Medicine—maintaining optimal health after 75 years old.

4. Representative Patients/Clients

In general, the representative clients of the present invention are looking for ways to coalesce available information from a multitude of sources (in particular the Internet and media) and to integrate the information into a comprehensive, integrated plan to sustain maximum health. Intervention in health is now becoming more relevant than in the past as they observe their aging parents and wish to avoid the consequences of inadequate or delayed intervention. They are burdened by the care-taking roles, yet do not want to place their parents in nursing home facilities. They also do not want to burden their own children in the future. Most importantly, they want to preserve their quality of life as long as possible in the later years. For the first time in history, a natural experiment in aging—created by the longer life expectancies—is leading to the recognition that prevention may offset or delay the ravages of time.

Health care consumers are becoming more enlightened and educated to options available for their health. This is leading to an increased involvement by patients in their own care. They want choices, but have been stymied by restrictive managed care policies. As a result, they have initiated an independent search for other means of achieving and maintaining health. Their proactive approach and the information availability have lead to a huge market in alternative medicine on a private fee for service basis. Yet, alternative medicine by itself is proving to be less than perfect. Emerging scientific findings make it increasingly clear that it is important to weave the best of western and eastern health philosophy together. This approach bridges the obstacles of ignorance in the traditional medical world while tapping into the advances available for each individual man or woman, whether it is herbal, hormones, or some combination thereof.

5. Benefits of the System and Method of the Present Invention

One aspect of the system and method of the present invention is to deliver customized strategies for each individual. This approach provides significant benefits that can not be recognized using the existing fragmented approach to medical care, including:

The ability to effectively attain, maintain and sustain health through coordinated lifestyle and therapeutic interventions.

Minimize the risks and shortcomings of fragmented care which;

Creates gaps in care provided,

Allows for conflicting treatments being provided, and

Eliminates accountability for the overall wellness of the clients.

Brings patient's voice into the process, acknowledging her beliefs, feelings, and/or fears, which impact the understanding and acceptance of therapeutic interventions and overall outcomes.

Enhances the physician-patient relationship by working with the patient to serve as active participants in their own health plan. For example, the collection of patient history before the visit allows the health care team to adapt the process based on the data and provides for more effective interventions during the visit.

Physician focus is significantly enhanced in the “patient-centered” environment of the present invention. The focus is on the patient and not on purely addressing symptoms and moving the patient through the system. In contrast, the managed care systems of the prior art limit the time a physician can spend with a patient, preventing them from providing “patient-centered,” integrated care (e.g., in conventional managed care systems, physicians typically spend an average of only 8 minutes with each patient).

Patient efficiency is maximized throughout the process by streamlining the care process coupled with the collection and dissemination of information. Patients do not have to coordinate care (and translate information) from multiple providers—thus it:

allows the patients to “own” the components of the health care process (e.g., information gathering and an opportunity to explore their own beliefs) which can not be effectively gathered during a visit, and

enables the medical team to fulfill the roles of guide, teacher and expert to discern value and offer recommendations.

The physician becomes a facilitator to identify, access, and coordinate appropriate care as opposed to serving as a “gatekeeper” to minimize the care provided. Effective health care and management tools can be used while eliminating misinformation and information overload for the patients.

By fulfilling this role of facilitator, the physician and clinical team develop a long-term relationship with the patient. This type of relationship, coupled with the trust that builds as a result of this relationship, provides improved outcomes via improved patient commitment to the process.

6. Implementation

An objective of the present invention is the implementation of an integrated health care delivery system, which uses a comprehensive focus to attain and maintain patient health. The manner of achieving this is a “patient-centered” system coordinated by an individual medical team that is accountable for coordination of all health-related activities.

The “patient-centered” approach of the present invention creates a new paradigm in health care delivery by providing health management methods that allow for effective patient-doctor partnering and that are focused on health/well-being and prevention. An aspect of this delivery model is the concept that a patient should own the knowledge to effect change in their health and have a vested interest in creating better outcomes and quality of life for themselves. Specifically, this approach is differentiated from traditional care via the following:

1) Approach: The approach of using a single specifically trained physician and clinical team provides:

Patient-Centered Care proactively focused on health and well-being,

Single Point Of Care coordinating all aspects of care including traditional medicine, alternative treatments, nutrition, exercise and behavior modification leading to improved outcomes, increased efficiency and reduced costs.

Accountability enabled by the coordination of all medical records and test results, access facilitation, feedback, accountability, recommendations unique to each individual patient (e.g., provides a customized ‘roadmap’ for each patient) while empowering the patients to participate in their care and provides the ability for patients to discern the critical issues.

2) Assessment Tool: The assessment tool of the present invention effectively captures and presents the data necessary to proactively, efficiently, and effectively complete the evaluation, and to develop a “road-map” for the patient that incorporates all aspects of a healthy life.

3) Protocols/Care Plans: The individual evidence-based care plans utilized to address specific aspects of the patient's health risks (e.g., osteoporosis and cardiac disease), which encompass a comprehensive approach (including, for example, nutrition, exercise, and psychological aspects) and provide a proven means to facilitate dramatic results. Additionally, the care plans (and the assessment tool) provide for reproducibility of the results in multiple locations and by all trained medical staff.

4) National Network of Providers: The National Network of Providers, which is comprised of over 2,000 of the most renowned experts in their respective fields provides the present invention with an unmatched network of resources. This network provides both nationwide coverage as well as expertise in all relevant specialties.

5) Full Spectrum Analysis Of Literature (evidence-based medicine)—provides practice guidelines customized to the individual's needs and beliefs, coupled with an ability to implement the plan while preventing misinformation and information overload.

An embodiment of the present invention operates through a single, centrally located center, which streamlines the start-up processes, refines the staffing model, and establishes a corporate identity. This center can be a freestanding facility. In an embodiment of the present invention, however, this clinic is affiliated with a well-known, upscale health club, spa or other entity. This affiliation provides the following benefits:

Operational synergies and facility access based on utilization of existing space and administrative staff/systems.

Marketing synergies and market credibility including:

Access to the partner's clients—whose client demographics correlate strongly with the representative clients of the present invention.

Joint marketing to extend the marketing reach.

Capitalizing on the existing image of the affiliate.

Capitalizing on the desirable destination aspect of the entity's location and the related population of visitors and residents.

For illustration purposes, this specification describes the present invention in the context of health care services. However, as one of ordinary skill in the art would appreciate, the systems and methods described herein apply equally well to other fields outside of this representative embodiment. For that reason, and notwithstanding the particular benefits associated with using the present invention in connection with health care services, the system and method described herein should be considered broadly useful in the field of client services.

In describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, unless that order is explicitly described as required by the description of the process in the specification. Otherwise, one skilled in the art can readily appreciate that the sequences may be varied and still remain within the spirit and scope of the present invention.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

What is claimed is:

1. A system for delivering integrated health care to a patient comprising:
(a) a site coordinator that creates a health portfolio for the patient;
(b) a nurse practitioner that answers questions raised by the patient concerning treatment;
(c) one or more allopathic specialists that review the health portfolio and propose allopathic treatments for the patient, wherein the nurse practitioner manages the one or more allopathic specialists;
(d) a complementary-alternative medicine manager that provides the patient with information on complementary-alternative treatments;
(e) one or more complementary-alternative medical providers that review the health portfolio and propose complementary-alternative treatments for the patient, wherein the complementary-alternative medicine manager manages the one or more complementary-alternative medical providers; and
(f) a physician that reviews the health portfolio, evaluates the proposed allopathic treatments and the proposed complementary-alternative treatments, presents the proposed allopathic and complementary-alternative treatments to the patient, and consults with the patient to establish a treatment plan for the patient.

2. The system of claim 1, wherein the health portfolio includes at least one of past medical records, medical history questionnaires completed by the patient, a comprehensive physical examination report, laboratory results, diagnostic results, a health maintenance calendar, laboratory comparison studies, and educational materials.

3. The system of claim 1, wherein the site coordinator, the nurse practitioner, the one or more allopathic specialists, the complementary-alternative medicine manager, the one or more complementary-alternative medical providers, and the physician operate out of a single medical site.

4. The system of claim 3, wherein the medical site is located within a distance proximate to one of a hospitality facility, a planned community, a medical facility, and a diagnostic center.

5. The system of claim 1, further comprising a database that stores the health portfolio, wherein the database is remotely accessible to the patient through a computer network.

6. The system of claim 1, wherein the one or more allopathic specialists include at least one of a nutritionist, an exercise physiologist, a physical therapist, a medical specialist, and a local primary care physician of the patient.

7. The system of claim I, wherein the one or more complementary-alternative medical providers include at least one of a lifestyle counselor, a behavioral health specialist, a Chinese medicine professional, a hypnotherapist, a chiropractor, a naturopathy specialist, a biofeedback therapist, and an energy work specialist.

8. A method for delivering integrated health care to a patient comprising:
collecting medical history information of the patient;
reviewing the medical history information to identify any additional medical information needed;
conducting an interview of the patient to obtain the additional medical information;
identifying consultations beneficial to the patient, wherein the identified consultations include allopathic consultations by allopathic providers and complementary-alternative medicine consultations by complementary-alternative medicine providers;
providing the patient with the identified consultations at a single medical site; and
providing a patient with a report of the results of the identified consultations.

9. The method of claim 8, further comprising providing the patient with ongoing care in accordance with the report.

10. The method of claim 8, further comprising providing the patient with remote online access to the report.

11. The method of claim 8, wherein the report includes at least one of past medical records, medical history questionnaires completed by the patient, a comprehensive physical examination report, laboratory results, diagnostic results, a health maintenance calendar, laboratory comparison studies, and educational materials.

12. The method of claim 8, wherein collecting medical history information comprises receiving answers through an online questionnaire submitted remotely by the patient.

13. The method of claim 8, wherein the allopathic providers include a physician and at least one of a nutritionist, an exercise physiologist, a physical therapist, a medical specialist, and a local primary care physician of the patient.

14. The method of claim 8, wherein the complementary-alternative providers include at least one of a lifestyle counselor, a behavioral health specialist, a Chinese medicine professional, a hypnotherapist, a chiropractor, a naturopathy specialist, a biofeedback therapist, and an energy work specialist.

15. The method of claim 8, wherein after conducting the interview and before identifying the consultations, the method further comprises arranging one of a laboratory and a diagnostic test of the patient and receiving results of the test.

16. The method of claim 8, wherein identifying consultations comprises holding an integrated team conference among the allopathic providers and the complementary-alternative medicine providers, wherein participants of the integrated team conference evaluate the medical history information and the additional medical information and select consultations associated with the participants' disciplines.

17. The method of claim 8, wherein the identified consultations include one or more of an integrated medical review, a comprehensive physical examination, an electrocardiogram with interpretation, a nutrition consultation, a lifestyle consultation, an exercise physiology evaluation, a bioelectrical impedance analysis, an elective consultation, a laboratory test, and a diagnostic test.

18. The method of claim 8, wherein the medical site is located within a distance proximate to one of a hospitality facility, a planned community, a medical facility, and a diagnostic center.

19. The method of claim 8, wherein the medical site is located on the premises of one of a hotel, resort, spa, and fitness club.

20. The method of claim 8, wherein providing the patient with a report includes meeting with the patient to discuss the results of the identified consultations.

21. A system for delivering health care to a patient comprising:
(a) a medical site that provides the patient with allopathic consultations and complementary-alternative medicine consultations; and
(b) a hospitality facility, wherein the medical site is located on the premises of the hospitality facility.

22. The system of claim 21, wherein the medical site comprises:
(i) an allopathic medical facility, wherein the allopathic medical facility includes a nurse practitioner, a physician, and an allopathic medical team; and
(ii) a complementary-alternative medicine facility, wherein the complementary-alternative medicine facility includes a complementary-alternative medicine manager and a complementary-alternative medicine team.

23. The system of claim 22, wherein the allopathic medical team includes one or more of a nutritionist, an exercise physiologist, a physical therapist, and a medical specialist.

24. The system of claim 22, wherein the complementary-alternative medicine team includes one or more of a lifestyle counselor, a behavioral health specialist, a Chinese medicine professional, a hypnotherapist, a chiropractor, a naturopathy specialist, a biofeedback therapist, and an energy work specialist.

25. The system of claim 21, wherein the medical site and the hospitality facility share administrative functions, wherein the functions include one or more of front desk reception, reservations, and scheduling.

26. The system of claim 21, wherein the hospitality facility comprises one of a hotel, resort, spa, and fitness club.

27. A method for delivering integrated health care to a patient comprising:
scheduling an appointment for the patient to visit a medical site;
receiving answers to medical information questions through a questionnaire completed the patient;
collecting medical records of the patient;
reviewing and summarizing the questionnaire answers and the medical records;
interviewing the patient before the visit to accomplish at least one of outlining preliminary recommendations for the visit, obtaining additional medical information, and arranging for one of a laboratory test and a diagnostic test to be conducted before the visit;
identifying allopathic and complementary-alternative medicine consultations to provide during the visit;
providing the allopathic and complementary-alternative medicine consultations during the visit to the medical site;
documenting results of the consultations; and
meeting with the patient to review the results.

28. The method of claim 27, wherein documenting comprises assembling a health portfolio that includes one or more of the questionnaire answers, a comprehensive physical examination report, laboratory test results, diagnostic test results, a health maintenance calendar, laboratory comparison studies, and educational materials.

29. The method of claim 28, further comprising delivering ongoing care to the patient by updating the health portfolio and providing the patient with remote secure online access to the health portfolio.

30. The method of claim 29, wherein delivering ongoing care comprises one of managing a health issue identified during the visit, researching a health issue that arises after the visit, and administering behavior modification programs.

31. The method of claim 27, wherein the medical site is located on the premises of a hospitality facility.

32. The method of claim 31, wherein scheduling further comprises scheduling a visit to the hospitality facility.

33. The method of claim 31, wherein identifying comprises holding at the medical site an integrated team conference among allopathic providers and complementary-alternative medicine providers, wherein participants of the integrated team conference evaluate the questionnaire answers and the medical records and identify consultations associated with the participants' disciplines.

34. The method of claim 31, wherein the questionnaire is an online questionnaire remotely completed by the patient.
